(19) United States
(12) Patent Application Publication
(10) Pub. No.: US 2012/0062183 A1
(43) Pub. Date: Mar. 15, 2012

(54) ELECTRONIC DEVICE AND CHARGING METHOD THEREOF

(75) Inventor: Margaret-Peyi Lin, Taipei Hsien (TW)

(73) Assignee: WISTRON CORPORATION, Taipei Hsien (TW)

(21) Appl. No.: 12/947,792

(22) Filed: Nov. 16, 2010

(30) Foreign Application Priority Data
Sep. 10, 2010 (TW) 99130687

(51) Int. Cl. H02J 7/04

(52) U.S. Cl. 320/162

(57) ABSTRACT

An electronic device and a charging method thereof are provided, wherein the electronic device has a battery and is connected to a power supply. In the charging method, it is determined whether a current time of the electronic device is in a specific time interval. During the specific time interval, it is determined whether a remaining power of the battery is more than a lower bound of power. If yes, the battery is stopped form being charged and the battery is solely used to keep the electronic device working; otherwise, the power supply is controlled and an intermittence charging procedure is used to charge the battery in accordance with the lower bound of power. While not in the specific time interval, a normal charging procedure is used to charge the battery. By switching between the two different charging procedures, purposes of charging effectively and lowering electricity bills are both achieved.

### CROSS-REFERENCE TO RELATED APPLICATION

This application claims the priority benefit of Taiwan application serial no. 99130687, filed on Sep. 10, 2010. The entirety of the above-mentioned patent application is hereby incorporated by reference herein and made a part of this specification.

### BACKGROUND OF THE INVENTION

1. Field of the Invention

The disclosure is related to a charging method, and in particular to a charging method which is able to switch between different charging procedures, and to an electronic device which uses the method.

2. Description of Related Art

In industrial and commercial societies, the pace of life for modern people are hastened and efficiency is required in every aspect. In order to fulfill requirements of convenience for electronic products used by modern people, electronic products are gradually developed towards trends of miniaturization, portability, and wireless transmission.

For laptop computers, not only do they have computing abilities almost comparable to those of desktop computers, the portability thereof enables users who roam around to process files, send and receive e-mails, browse the Internet, and play multimedia files anytime and anywhere. However, when a user is outdoors, power of a battery must be relied on to keep a laptop computer working. Hence, for most users, when they use laptop computers at fixed locations such as at home or in an office, the laptop computers are generally connected to power sources through power adapters, so that batteries are in a fully charged state.

Although the adoption of such a method may reduce the chance of being unable to use a laptop computer due to depletion of power of the battery when one is outdoors, continuous charging of the battery under unnecessary circumstances also leads to high electricity bills easily. For a planet whose resources are gradually running out, incessant charging of the battery further wastes power, thereby causing very negative effects for the planet.

### SUMMARY OF THE INVENTION

In light of the above, the disclosure provides a charging method which adopts different methods for charging an electronic device according to a time interval that the electronic device is in.

The disclosure provides an electronic device which is able to determine whether to charge a battery according to a time and a remaining power of the battery, and when it determines to charge the battery, different charging procedures are adopted according to different times.

The disclosure provides a charging method used for an electronic device which is equipped with a battery and connected to a power source. The charging method includes determining whether a current time of the electronic device is in a specific time interval. If the current time is in the specific time interval, it is determined whether a remaining power of the battery is more than a lower bound of power. If the remaining power is more than the lower bound of power, the electronic device is kept working by solely relying on the battery. If the remaining power is less than or equal to the lower bound of power, before the current time of the electronic device leaves the specific time interval, the power source is controlled to use an intermittence charging procedure to charge the battery according to the lower bound of power.

According to an embodiment of the disclosure, after the step of determining whether the current time of the electronic device is in the specific time interval, the charging method further includes: when the current time is not in the specific time interval, using the power source to continuously charge the battery until the battery is fully charged or until the power source cannot charge the battery.

According to an embodiment of the disclosure, the step of keeping the electronic device working by relying on the battery further includes stopping using the power source to charge the battery, and reducing power consumption of at least one specific component in the electronic device.

According to an embodiment of the disclosure, the step of controlling the power source to use the intermittence charging procedure to charge the battery according to the lower bound of power includes configuring an upper bound of power corresponding to the lower bound of power. The upper bound of power is more than the lower bound of power. After controlling the power source to charge the battery so that the remaining power of the battery reaches the upper bound of power, the power source is stopped from being used to charge the battery, the electronic device is kept working by solely relying on the battery, and power consumption of at least one specific component in the electronic device is reduced.

According to an embodiment of the disclosure, the step of configuring the upper bound of power corresponding to the lower bound of power includes determining a remaining time until leaving the specific time interval according to the current time of the electronic device. A required power for keeping the electronic device working during the remaining time is calculated. When the required power is less than or equal to the lower bound of power, a sum of the lower bound of power and a predetermined power is used as the upper bound of power. Moreover, when the required power is more than the lower bound of power, the required power is used as the upper bound of power.

From another point of view, the disclosure provides an electronic device which includes a battery, a power adapter, a basic input/output system (BIOS), and an embedded controller. The power adapter supplies power to the electronic device. The BIOS determines whether the current time of the electronic device is in the specific time interval. The embedded controller is coupled to the battery, the power adapter, and the BIOS. When the BIOS determines that the current time of the electronic device is in the specific time interval, the embedded controller determines whether the remaining power of the battery is more than the lower bound of power. If the remaining power is more than the lower bound of power, the electronic device is kept working by solely relying on the battery. If the remaining power is less than or equal to the lower bound of power, before the BIOS determines that the current time of the electronic device leaves the specific time interval, the embedded controller controls the power adapter to use an intermittence charging procedure to charge the battery with the power source according to the lower bound of power.

According to an embodiment of the disclosure, when the BIOS determines that the current time of the electronic device is not in the specific time interval, the embedded controller controls the power adapter to continuously charge the battery with the power source until the battery is fully charged or until the power source cannot charge the battery.

According to an embodiment of the disclosure, when the remaining power is more than the lower bound of power, the embedded controller controls the power adaptor to stop charging the battery with the power source, and the BIOS reduces power consumption of at least one specific component in the electronic device.

According to an embodiment of the disclosure, the embedded controller configures an upper bound of power corresponding to the lower bound of power, wherein the upper bound of power is more than the lower bound of power. When the power adapter charges the battery with the power source until the remaining power of the battery reaches the upper bound of power, the embedded controller controls the power adapter to stop charging the battery with the power source, the electronic device is kept working by solely relying on the battery, and the BIOS reduces power consumption of at least one specific component in the electronic device.

According to an embodiment of the disclosure, the BIOS determines, according to the current time of the electronic device, a remaining time until leaving the specific time interval, and transmits the remaining time to the embedded controller. The embedded controller calculates a required power for keeping the electronic device working during the remaining time, uses a sum of the lower bound of power and a predetermined power as the upper bound of power when the required power is less than or equal to the lower bound of power, and uses the required power as the upper bound of power when the required power is more than the lower bound of power.

Due to the above, in the specific time interval, it is determined whether to charge the battery or to keep the electronic device working by solely relying on the remaining power according to the remaining power in the electronic device. Therefore, timing for charging and charging power are effectively determined, so that charging of the battery for prolonged periods under unnecessary circumstances is avoided, thereby achieving a goal of not wasting power.

In order to make the aforementioned and other objects, features and advantages of the disclosure comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic block diagram of an electronic device according to an embodiment of the disclosure.

FIG. 2 is a schematic flowchart of a charging method according to an embodiment of the disclosure.

FIG. 3 is a schematic flowchart of a charging method according to another embodiment of the disclosure.

### DESCRIPTION OF EMBODIMENTS

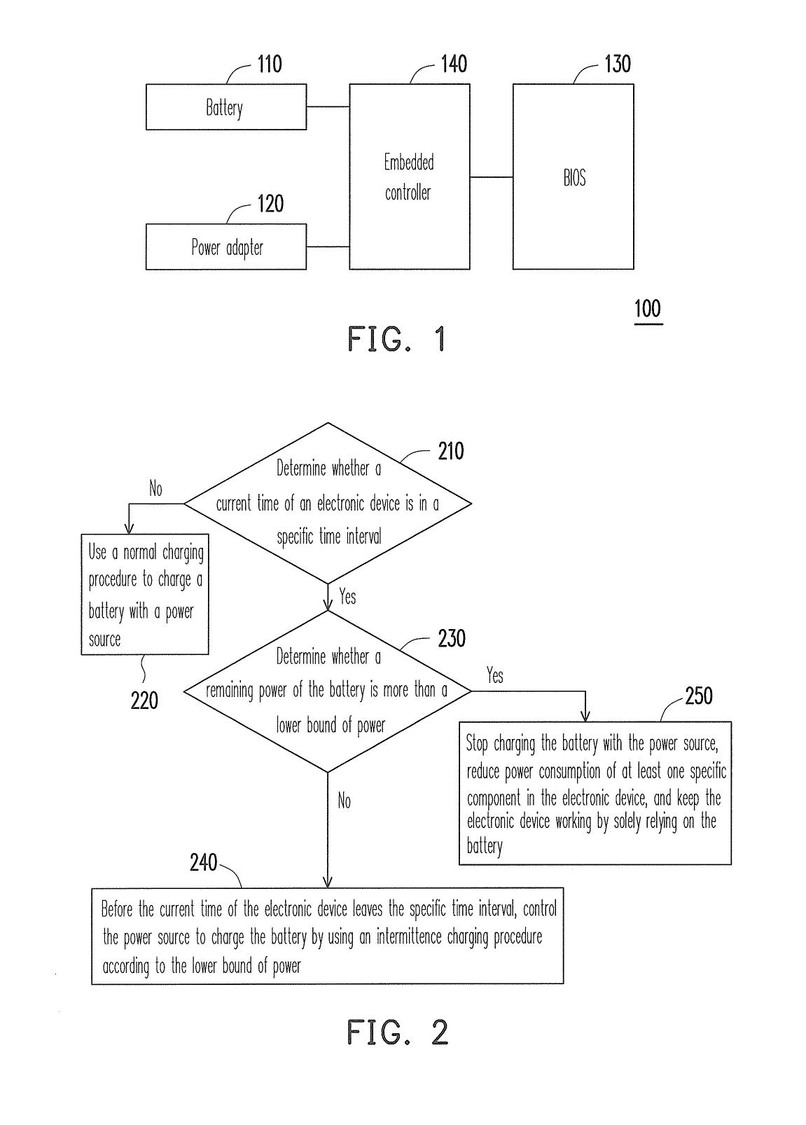

FIG. 1 is a schematic block diagram of an electronic device according to an embodiment of the disclosure. Referring to FIG. 1, an electronic device 100 includes a battery 110, a power adapter 120, a basic input/output system (BIOS) 130, and an embedded controller 140. According to the present embodiment, the electronic device 100 is, for example, a laptop computer. The disclosure, however, is not limited to this configuration.

The power adapter 120 is used for receiving power and supplying power to the electronic device 100. For example, the power adapter 120 receives AC power by being connected to an electrical outlet through a power cord, coverts the AC power to DC power, and supplies the converted power to the electronic device 100.

The BIOS 130 is in charge of communication between hardware and an operating system of the electronic device 100. According to the present embodiment, the BIOS 130 is especially used for obtaining a current time of the electronic device 100, so as to determine whether the current time is in a specific time interval. According to an embodiment, the specific time interval is, for example, a peak power consumption period. The disclosure, however, is not limited to this configuration. For example, the electronic device 100 is able to provide an input interface to let the user configure beginning and ending time points of the peak power consumption period, and the BIOS 130 is able to determine, according to values input by the user, whether the current time of the electronic device 100 is in the peak power consumption period. Moreover, the BIOS 130 may also be connected to a network through a network module (not shown) of the electronic device 100, so as to obtain the peak power consumption period, and to further determine whether the current time of the electronic device 100 is in the peak power consumption period.

The embedded controller 140 is coupled to the battery 110, the power adapter 120, and the BIOS 130. The embedded controller 140 is, for example, a keyboard controller (KBC), and is able to determine whether to charge the electronic device 100 and what charging procedure to be used according to a determination result provided by the BIOS 130 and a remaining power in the battery 110.

In order to describe detailed operations of the electronic device 100, another embodiment is described in the following. FIG. 2 is a schematic flowchart of a charging method according to an embodiment of the disclosure. Please refer to both FIGS. 1 and 2.

In a step 210, after the BIOS 130 obtains the current time of the electronic device 100, it is determined whether the current time is in the specific time interval.

If the current time is not in the specific time interval, according to a step 220, before the BIOS 130 determines that the current time of the electronic device 100 is in the specific time interval, the embedded controller 140 controls the power adapter 120 to use a normal charging procedure to charge the battery 110 with a power source. When the power adapter 120 performs the normal charging procedure, the power source is continuously used for charging until the battery 110 is fully charged or until the battery 110 can no longer be charged by the power source.

However, if the current time is in the specific time interval, as shown in a step 230, the embedded controller 140 determines whether the remaining power of the battery 110 is more than a predetermined lower bound of power. According to the present embodiment, an interface may be provided by the BIOS 130 to enable the user to configure the lower bound of power. Configuration of the lower bound of power is for ensuring that the remaining power of the battery 110 does not become less than the lower bound of power.

If the remaining power is less than or equal to the lower bound of power, as shown in a step 240, before the BIOS 130 determines that the current time of the electronic device 100 leaves the specific time interval, the embedded controller 140 controls the power adapter 120 to use an intermittence charging procedure to charge the battery 110 with the power source according to the lower bound of power. According to the present embodiment, when the power adapter 120 performs the intermittence charging procedure, the battery 110 is not fully charged. Instead, the battery 110 is charged according to an instruction is given by the embedded controller 140 which refers to the lower bound of power, so that the battery 110 is charged to a specific power.

When the remaining power is more than the lower bound of power, it means that the battery 110 has power that is usable. Hence, as shown in a step 250, the embedded controller 140 controls the power adapter 120 to stop charging the battery 110 with the power source. In other words, the electronic device 100 at this moment works by solely relying on power in the battery 110. The BIOS 130 uses an interruption mechanism to communicate with the operating system working in the electronic device 100, so as to make the operating system recognize that the electronic device 100 is in a state in which the power adapter 120 is not connected to the power source. Moreover, when the power adapter 120 stops supplying power and the battery 110 is required to keep the electronic device 100 working, in order to increase endurance of the battery 110, the BIOS 130 reduces power consumption of at least one specific component in the electronic device 100. For example, the BIOS 130 may reduce a speed of a central processing unit (not shown), turn off a display (not shown) of the electronic device 100, or reduce a brightness of the display. For some less frequently used or less important components, the BIOS 130 may also make them enter sleep mode or temporarily stop supplying power to them.

After the electronic device 100 is turned on, the steps shown in FIG. 2 are repeatedly performed, so as to fully charge the battery 110 by using the power source connected to the power adapter 120 at times other than the specific time interval. During the specific time interval and when the remaining power in the battery 110 is less than or equal to the lower bound of power, the battery 110 is charged to a specific power. In addition, even if the power adapter 120 is able to continuously receive power, during the specific time interval and when the remaining power of the battery 110 is more than the lower bound of power, the electronic device 100 is kept working directly by the power in the battery 110, and the battery 110 is not charged. Therefore, even if the electronic device 100 is coupled to both the battery 110 and the power source, different methods of power usage and charging may be adopted under different circumstances.

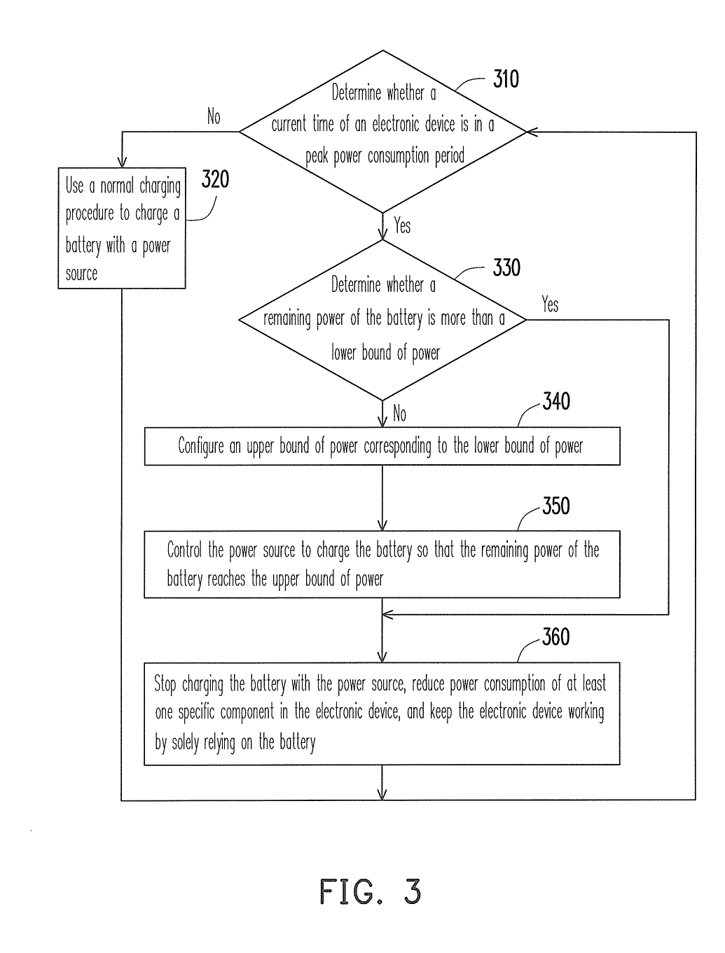

FIG. 3 is a schematic flowchart of a charging method according to another embodiment of the disclosure. According to the following embodiment, the peak power consumption period is exemplarily used as the specific time interval. Generally, electricity rates are higher during the peak power consumption period, and are lower at times other than the peak power consumption period. By using the charging method shown in FIG. 3, not only is the electronic device 100 kept working, electricity bills for charging are also lowered.

Please refer to both FIGS. 1 and 3. As shown in a step 310, the BIOS 130 determines whether the current time of the electronic device 100 is in the peak power consumption period.

If the current time is not in the peak power consumption period, as shown in a step 320, the embedded controller 140 controls the power adapter 120 to use the normal charging procedure to charge the battery 110 with the power source (in other words, the power source is continuously used for charging until the battery 110 is fully charged or until the battery 110 can no longer be charged by the power source). Afterwards, the charging method according to the present embodiment returns to the step 310, and the BIOS 130 determines again whether the current time of the electronic device 100 is in the specific time interval.

If the current time is in the peak power consumption period, as shown in a step 330, the embedded controller 140 determines whether the remaining power of the battery 110 is more than the lower bound of power.

When the remaining power is more than the lower bound of power, as shown in a step 360, the embedded controller 140 controls the power adapter 120 to stop charging the battery 110 with the power source, and the electronic device 100 is kept working by solely relying on the battery 110. The BIOS 130 reduces the power consumption of at least one specific component in the electronic device 100, so as to ensure that the electronic device 100 has a lower power consumption rate when power is supplied by the battery 110.

In the step 330, if it is determined that the remaining power is less than or equal to the lower bound of power, the embedded controller 140 controls the power adapter 120 to use the intermittence charging procedure to charge the battery 110 according to the lower bound of power. In detail, in a step 340, the embedded controller 140 configures an upper bound of power corresponding to the lower bound of power, wherein the upper bound of power is more than the lower bound of power.

According to an embodiment, the embedded controller 140 is able to obtain the upper bound of power corresponding to the lower bound of power by consulting a chart. According to another embodiment, the BIOS 130 determines, according to the current time, a remaining time until leaving the peak power consumption period, and transmits the remaining time to the embedded controller 140. Next, the embedded controller 140 calculates the required power for keeping the electronic device 100 working during the remaining time. When the required power is less than or equal to the lower bound of power, the embedded controller 140 uses a sum of the lower bound of power and a predetermined power as the upper bound of power. When the required power is more than the lower bound of power, the embedded controller 140 uses the required power as the upper bound of power. Next, in a step 350, the embedded controller 140 controls the power adapter 120 to charge the battery 110 with the power source until the power of the battery 110 reaches the upper bound of power. Hence it is ensured that the power of the battery 110 is not less than the lower bound of power.

For example, assume that the lower bound of power is 15% of the total power of the battery 110. If the required power for keeping the electronic device 100 working during the remaining time is 50% of the total power of the battery 110, the embedded controller 140 controls the power adapter 120 to charge the battery 110 with the power source until the power of the battery 110 is 50% of the total power. However, if the required power for keeping the electronic device 100 working during the remaining time is 10% of the total power of the battery 110, and the predetermined power is 20% of the total power of the battery 110, the embedded controller 140 controls the power adapter 120 to charge the battery 110 until the power thereof is 30% of the total power.

When the battery is charged to the upper bound of power, according to a step 360, the embedded controller 140 controls the power adapter 120 to stop charging the battery 110 with the power source, and the electronic device 100 is kept working by solely relying on the battery 110. The BIOS 130 also reduces power consumption of at least one specific component, so as to enhance endurance of the battery 110.

Afterwards, the charging method according to the present embodiment returns to the step 310, and the BIOS 130 determines again whether the current time of the electronic device 100 is in the peak power consumption period. The above steps are repeated, so as to use the normal charging procedure to fully charge the battery 110 at times other than the peak power consumption period, thereby taking advantage of lower electricity rates. On the other hand, during the peak power consumption period wherein electricity rates are higher, it is determined, according to a comparison between the remaining power of the battery 110 and the lower bound of power, whether to keep the electronic device 100 working by directly using only the remaining power of the battery 110 or to only charge the battery 110 to a specific power (i.e. the upper bound of power). Hence unnecessary charging of the battery 110 when the electricity rates are higher and high electricity bills are avoided. Moreover, since the charging method according to the present embodiment is also able to ensure that the remaining power of the battery 110 is not less than the lower bound of power, even if the user unplugs the power adapter 120, the electronic device 100 is able to be kept working by using the remaining power in the battery 110.

In summary, in the electronic device and the charging method thereof of the disclosure, it is determined whether the electronic device is to be charged according to whether the current time is in the specific time interval and the remaining power of the battery of the electronic device. If it is determined that the remaining power is enough, even if the electronic device is connected to the power source, the battery is not charged, and the electronic device is kept working by solely relying on the battery. Otherwise, if it is determined that charging is to be performed, switching between the different charging procedures is automatically performed according to whether the current time is in the specific time interval. Therefore, not only is it ensured that the electronic device is kept working by charging at appropriate moments, excessive charging and waste of electricity are prevented. If the specific time interval is configured as the peak power consumption period wherein electricity rates are higher, effects of reducing electricity bills are further achieved.

It will be apparent to those skilled in the art that various modifications and variations can be made to the disclosure without departing from the scope or spirit of the disclosure. In view of the foregoing, it is intended that the disclosure cover modifications and variations of this disclosure provided they fall within the scope of the following claims and their equivalents.

What is claimed is:

1. A charging method for an electronic device, the electronic device being equipped with a battery and being connected to a power source, the method comprising:
determining whether a current time of the electronic device is in a specific time interval;
if the current time is in the specific time interval, determining whether a remaining power of the battery is more than a lower bound of power;
if the remaining power is more than the lower bound of power, keeping the electronic device working by solely relying on the battery; and
if the remaining power is less than or equal to the lower bound of power, before the current time of the electronic device leaves the specific time interval, controlling the power source to use an intermittence charging procedure to charge the battery according to the lower bound of power.

2. The charging method as claimed in claim 1, wherein after the step of determining whether the current time of the electronic device is in the specific time interval, the method further comprising:
if the current time is not in the specific time interval, before the current time of the electronic device enters the specific time interval, using the power source to continuously charge the battery until the battery is fully charged or until the power source cannot charge the battery.

3. The charging method as claimed in claim 1, wherein the step of keeping the electronic device working by solely relying on the battery further comprises:
stopping using the power source to charge the battery; and
reducing power consumption of at least one specific component in the electronic device.

4. The charging method as claimed in claim 1, wherein the step of controlling the power source to use the intermittence charging procedure to charge the battery according to the lower bound of power comprises:
configuring an upper bound of power corresponding to the lower bound of power, wherein the upper bound of power is more than the lower bound of power;
after controlling the power source to charge the battery so that the remaining power reaches the upper bound of power, stopping using the power source to charge the battery, and keeping the electronic device working by solely relying on the battery; and
reducing power consumption of at least one specific component in the electronic device.

5. The charging method as claimed in claim 4, wherein the step of configuring the upper bound of power corresponding to the lower bound of power comprises:
determining a remaining time until leaving the specific time interval according to the current time of the electronic device;
calculating a required power for keeping the electronic device working during the remaining time;
when the required power is less than or equal to the lower bound of power, using a sum of the lower bound of power and a predetermined power as the upper bound of power; and
when the required power is more than the lower bound of power, using the required power as the upper bound of power.

6. An electronic device, comprising:
a battery;
a power adapter, configured to supply power to the electronic device;
a basic input/output system (BIOS), determining whether a current time of the electronic device is in a specific time interval; and
an embedded controller, coupled to the battery, the power adapter, and the BIOS, when the BIOS determines that the current time of the electronic device is in the specific time interval, the embedded controller determining whether a remaining power in the battery is more than a lower bound of power, wherein
if the remaining power is more than the lower bound of power, the electronic device kept working by solely relying on the battery,
if the remaining power is less than or equal to the lower bound of power, before the BIOS determines that the current time of the electronic device leaves the specific time interval, the embedded controller controls the power adapter to use an intermittence charging procedure to charge the battery according to the lower bound of power.

7. The electronic device as claimed in claim 6, wherein when the BIOS determines that the current time of the electronic device is not in the specific time interval, the embedded controller controls the power adapter to use the power source to continuously charge the battery until the battery is fully charged or until the power source cannot charge the battery.

8. The electronic device as claimed in claim 6, wherein when the embedded controller determines that the remaining power of the battery is more than the lower bound of power, the embedded controller controls the power adapter to stop using the power source to charge the battery, and the BIOS reduces power consumption of at least one specific component in the electronic device.

9. The electronic device as claimed in claim 6, wherein the embedded controller configures an upper bound of power corresponding to the lower bound of power, and the upper bound of power is more than the lower bound of power,
when the power adapter uses the power source to charge the battery until the remaining power of the battery reaches the upper bound of power, the embedded controller controls the power adapter to stop using the power source to charge the battery, the electronic device is kept working by solely relying on the battery, and the BIOS reduces power consumption of at least one specific component in the electronic device.

10. The electronic device as claimed in claim 9, wherein the BIOS determines a remaining time until leaving the specific time interval according to the current time of the electronic device, and transmits the remaining time to the embedded controller,
the embedded controller calculates a required power for keeping the electronic device working during the remaining time, uses a sum of the lower bound of power and a predetermined power as the upper bound of power when the required power is less than or equal to the lower bound of power, and uses the required power as the upper bound of power when the required power is more than the lower bound of power.
